(19) United States
(12) Patent Application Publication
(10) Pub. No.: US 2026/0267297 A1
(43) Pub. Date: Sep. 10, 2026

(54) SYSTEM

(71) Applicant: SOFTBANK GROUP CORP., Tokyo (JP)

(72) Inventor: Toshihide MATSUNOBU, Tokyo (JP)

(73) Assignee: SOFTBANK GROUP CORP., Tokyo (JP)

(21) Appl. No.: 19/555,311

(22) Filed: Mar. 3, 2026

Related U.S. Application Data
(60) Provisional application No. 63/766,578, filed on Mar. 4, 2025.

(51) Int. Cl. G05B 13/02

(52) U.S. Cl. CPC G05B 13/027

(57) ABSTRACT

A spherical device designed to address insufficient exercise and lack of mental stimulation in cats is provided. This device incorporates an accelerometer, gyroscope, infrared sensor, and camera sensor to detect the cat's movements and behavior in real time. The device analyzes the cat's behavioral patterns using generative AI, learning the cat's preferences and play style. Based on this, the device adjusts its speed and direction, using sound and light to continuously capture the cat's interest. Users can remotely control the device via smartphone or tablet to customize the cat's play experience. This stimulates the cat's natural hunting instincts, enabling a healthy and active lifestyle. The device functions as an effective tool for promoting cat health and well-being, while also providing owners with a reliable means to manage their cat's health with peace of mind.

### CROSS-REFERENCE TO RELATED APPLICATION

This application claims priority under 35 U.S.C. § 119 to U.S. Provisional Patent Application No. 63/766,578, filed on Mar. 4, 2025, the entire contents of which are incorporated herein by reference.

### BACKGROUND

### Technical Field

The present disclosure relates to a system.

### Related Art

Japanese Patent Application Publication Laid-Open (JP-A) No. 2022-180282 discloses a persona chatbot control method performed by at least one processor, comprising: a step of receiving a user utterance; a step of adding to the user utterance a prompt containing a description of the chatbot's persona and related instructions; a step of encoding the prompt; and a step of inputting the encoded prompt into a language model to generate a chatbot utterance in response to the user utterance.

### SUMMARY

A system and method for solving health issues in cats kept indoors, stemming from insufficient exercise and lack of mental stimulation is provided. In modern living environments, cats tend to spend extended periods indoors, often resulting in insufficient exercise. Lack of exercise can lead to health issues such as obesity, stress, and behavioral problems. Furthermore, cats are animals with inherent hunting instincts; without appropriate stimulation, they can become mentally bored and stressed. This invention aims to solve these problems by providing a device that stimulates a cat's natural hunting instincts and promotes exercise. The device analyzes a cat's movements and behavioral patterns in real time, providing appropriate reactions and stimuli tailored to the cat's preferences and play style. This keeps the cat engaged and encourages active exercise. Furthermore, remote operation via smartphone allows owners to customize their cat's play experience, providing an effective means to promote the cat's health and well-being. This helps reduce health problems caused by lack of exercise and mental stimulation, enabling cats to lead more active and healthy lives.

As a means to solve the problem, a spherical device equipped with multiple sensor units, including an accelerometer, gyroscope, infrared sensor, and camera sensor is provided. This device collects data from these sensor units to detect the cat's movements and behavioral patterns in real time. Furthermore, the device incorporates a generative AI unit that receives data from the sensor units and analyzes the cat's movements and behavioral patterns. This AI unit learns the cat's preferences and play styles, controlling the device to provide appropriate reactions and stimulation. Based on the AI unit's analysis results, the control unit adjusts the device's movements, varying its speed and direction to maintain the cat's interest.

The device also incorporates speakers and LED lights, enabling it to attract the cat's attention using sound and light. Furthermore, the device features a communication unit, allowing remote operation via a smartphone. Users can customize the device's movements and settings through a dedicated application, adjusting the cat's play style. In this way, the device provides an effective means to alleviate the cat's lack of exercise and deliver mental stimulation

### BRIEF DESCRIPTION OF THE DRAWING

FIG. 1 is a conceptual diagram showing an example configuration of the data processing system according to the first embodiment.

FIG. 2 is a conceptual diagram showing an example of key functions of the data processing device and smart device according to the first embodiment.

FIG. 3 is a conceptual diagram showing an example configuration of the data processing system according to the second embodiment.

FIG. 4 is a conceptual diagram showing an example of the main functions of the data processing device and smart glasses according to the second embodiment.

FIG. 5 is a conceptual diagram showing an example configuration of a data processing system according to a third embodiment.

FIG. 6 is a conceptual diagram showing an example of the main functions of the data processing device and headset-type terminal according to the third embodiment.

FIG. 7 is a conceptual diagram showing an example configuration of a data processing system according to the fourth embodiment.

FIG. 8 is a conceptual diagram showing an example of the main functions of the data processing device and robot according to the fourth embodiment.

FIG. 9 shows an emotion map onto which multiple emotions are mapped.

FIG. 10 shows an emotion map onto which multiple emotions are mapped.

### DETAILED DESCRIPTION

The following describes an example embodiment of a system according to the present disclosure with reference to the accompanying drawings.

First, the terminology used in the following description is explained.

In the following embodiments, a processor (hereinafter simply referred to as a "processor") may be a single arithmetic unit or a combination of multiple arithmetic units. Furthermore, the processor may be a single type of arithmetic unit or a combination of multiple types of arithmetic units. Examples of processing units include a CPU (Central Processing Unit), a GPU (Graphics Processing Unit), a GPGPU (General-Purpose Computing on Graphics Processing Units), an APU (Accelerated Processing Unit), and the like.

In the following embodiments, signed RAM (Random Access Memory) is a memory where information is temporarily stored and is used as working memory by the processor.

In the following embodiments, the signed storage is one or more non-volatile storage devices that store various programs and various parameters, etc. Examples of non-volatile storage devices include flash memory (SSD (Solid State Drive)), magnetic disks (e.g., hard disk), or magnetic tape.

In the following embodiments, the communication I/F (Interface) is an interface that includes a communication processor and an antenna, among other components. The communication I/F governs communication between multiple computers. Examples of communication standards applicable to the communication I/F include wireless communication standards such as 5G (5th Generation Mobile Communication System), Wi-Fi (registered trademark), or Bluetooth (registered trademark).

In the following embodiments, "A and/or B" is synonymous with "at least one of A and B." That is, "A and/or B" means it may be only A, only B, or a combination of A and B. Furthermore, in this specification, when three or more items are connected using "and/or," the same concept applies as for "A and/or B".

### First Embodiment

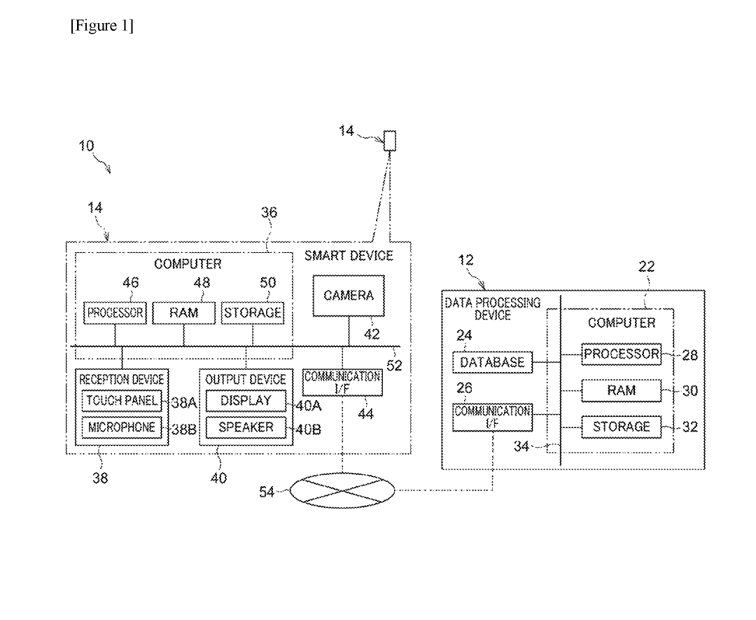

FIG. 1 shows an example configuration of the data processing system 10 according to the first embodiment.

As shown in FIG. 1, the data processing system 10 includes a data processing device 12 and a smart device 14. An example of the data processing device 12 is a server.

The data processing device 12 includes a computer 22, a database 24, and a communication I/F 26. The computer 22 is an example of a "computer" according to the technology of the present disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 include a WAN (Wide Area Network) and/or a LAN (Local Area Network).

The smart device 14 includes a computer 36, a reception device 38, an output device 40, a camera 42, and a communication I/F 44. The computer 36 includes a processor 46, RAM 48, and storage 50. The processor 46, RAM 48, and storage 50 are connected to a bus 52. The reception device 38, output device 40, and camera 42 are also connected to the bus 52. The reception device 38, output device 40, and camera 42 are also connected to the bus 52.

The reception device 38 includes a touch panel 38A and a microphone 38B, etc., and receives user input. The touch panel 38A receives user input via contact with an indicator (e.g., a pen or finger) by detecting such contact. The microphone 38B receives voice-based user input by detecting the user's voice. The control unit 46A transmits data indicating the user input received via the touch panel 38A and microphone 38B to the data processing unit 12. Within the data processing unit 12, the specific processing unit 290 acquires the data indicating the user input.

Output device 40 includes display 40A and speaker 40B, among others, and presents data to user 20 by outputting it in a form perceptible to user 20 (e.g., audio and/or text). Display 40A displays visual information such as text and images according to instructions from processor 46. Speaker 40B outputs audio according to instructions from processor 46. Camera 42 is a compact digital camera equipped with an optical system including a lens, aperture, and shutter, and an imaging element such as a CMOS (Complementary Metal-Oxide-Semiconductor) image sensor or a CCD (Charge Coupled Device) image sensor.

The communication interface 44 is connected to the network 54. The communication interfaces 44 and 26 manage the exchange of various information between processor 46 and processor 28 via network 54.

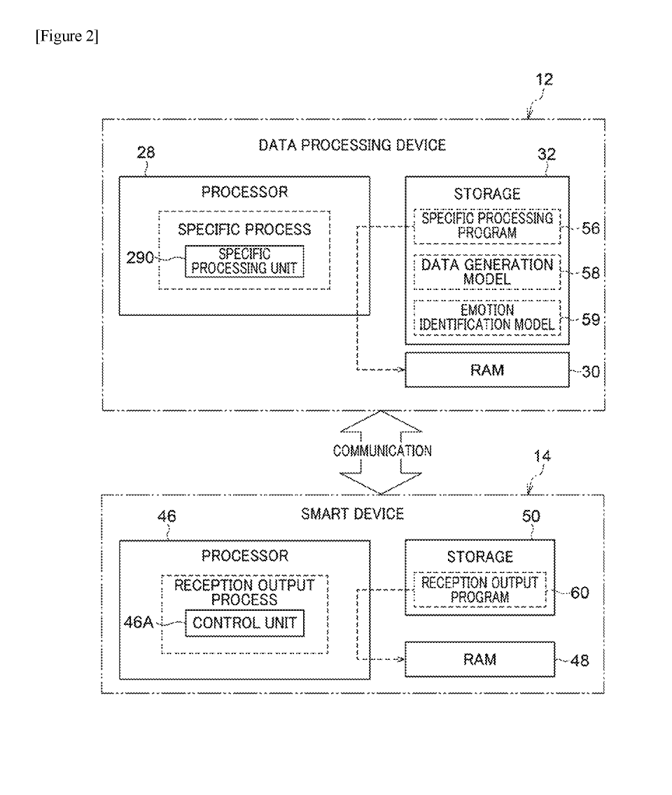

FIG. 2 shows an example of the main functions of the data processing device 12 and the smart device 14.

As shown in FIG. 2, specific processing is performed by processor 28 in data processing device 12. Specific processing program 56 is stored in storage 32. Specific processing program 56 is an example of a "program" related to the technology of this disclosure. The processor 28 reads the specific processing program 56 from the storage 32 and executes the read specific processing program 56 on the RAM 30. The specific processing is realized by the processor 28 operating as a specific processing unit 290 according to the specific processing program 56 executed on the RAM 30.

Storage 32 stores a data generation model 58 and an emotion identification model 59. The data generation model 58 and emotion identification model 59 are used by specific processing unit 290. Specific processing unit 290 can estimate a user's emotion using emotion identification model 59 and perform specific processing using the user's emotion. The emotion estimation function (emotion identification function) using the emotion identification model 59 performs various estimations and predictions concerning the user's emotion, including estimation and prediction of the user's emotion, but is not limited to such examples. Furthermore, estimation and prediction of emotion also includes, for example, analysis (parsing) of emotion.

The smart device 14 performs reception output processing via the processor 46. The reception output program 60 is stored in the storage 50. The reception output program 60 is used in conjunction with the specific processing program 56 by the data processing system 10. The processor 46 reads the reception output program 60 from the storage 50 and executes the read reception output program 60 on the RAM 48. The specific processing is performed by the processor 46 operating as a control unit 46A according to the specific processing program 60 executed on the RAM 48. Note that the smart device 14 may also have data generation models and emotion identification models similar to the data generation model 58 and emotion identification model 59, and may perform processing similar to that of the specific processing unit 290 using these models. The reception output processing is realized by the processor 46 operating as the control unit 46A according to the reception output program 60 executed on the RAM 48.

Other devices besides the data processing device 12 may also have the data generation model 58. For example, a server device (e.g., a generation server) may have the data generation model 58. In this case, the data processing device 12 communicates with the server device having the data generation model 58 to obtain processing results (such as prediction results) obtained using the data generation model 58. Furthermore, the data processing device 12 may be the server device itself, or it may be a terminal device owned by a user (e.g., a mobile phone, robot, home appliance, etc.). Next, an example of processing by the data processing system 10 according to the first embodiment will be described.

### Example 1

The flow of the specific processing in Example 1 is described below. The components of the system described below are implemented by the data processing device 12 and the smart device 14. The data processing device 12 is referred to as the "server," and the smart device 14 is referred to as the "terminal."

### Implementation Examples for Carrying Out the Present Invention

As an embodiment for implementing the present invention, a system that realizes a spherical cat play device via a server and a terminal will be described in further detail. This system aims to alleviate cats' lack of exercise and mental stimulation and comprises the following components and functions.

The device body has a spherical outer shell and houses multiple sensors internally. Specifically, it includes an accelerometer, a gyroscope, an infrared sensor, and a camera sensor. The accelerometer measures the device's movement acceleration, detecting how fast the cat is chasing the device. The gyroscope detects the device's rotation and tilt, determining its direction of movement. The infrared sensor detects the cat's body temperature to measure how close the cat is to the device. The camera sensor visually tracks the cat's movements, recording its behavior in detail.

Data from these sensors is transmitted to a server via a communication module built into the device. The communication module uses wireless communication technology to send data to the server in real time. The server analyzes this data using generative AI to learn the cat's behavioral patterns and preferences. For example, the server analyzes what speed the cat prefers when chasing the device and what direction changes interest it. It also learns how the cat reacts to specific sounds or lights, accumulating data to provide optimal stimulation.

The analysis results from the server are sent back to the device, and the device's control unit adjusts its operation based on this information. The control unit changes the device's speed and direction to keep the cat interested. For example, the device can suddenly change direction or increase speed to maintain the cat's interest. Furthermore, the device is equipped with a speaker and LED lights, which can play sounds or flash lights based on instructions from the server to attract the cat's attention. The speaker can play sounds that cats prefer, and the LED light can flash in various colors and patterns to capture the cat's interest.

Furthermore, users can remotely control the device using terminals such as smartphones or tablets. A dedicated application is installed on the terminal, allowing users to customize the device's movements and settings through this application. For example, users can manually change the device's speed or set the timing for playing specific sounds. The application also displays the device's current status and the cat's behavioral data in real time, providing an interface for users to adjust how the cat plays. The application can also monitor the cat's health status and activity level, providing appropriate advice to the user.

In this way, the present invention provides an effective means to innovate cat play using a server and terminal, thereby promoting the cat's health and well-being. The device functions as a tool to stimulate the cat's natural hunting instincts and prevent lack of exercise. This enables the cat to lead a more active and healthy life.

### System Configuration

The system according to this embodiment comprises a sensor unit, a communication unit, a generative AI unit, a control unit, an acoustic/visual stimulus unit, and a user interface unit. The sensor unit includes an accelerometer, a gyroscope, an infrared sensor, and a camera sensor to detect the cat's movements and behavior. The accelerometer measures the device's speed and acceleration to detect how fast the cat is chasing the device. The gyro sensor detects the device's rotation and tilt to determine its direction of movement. The infrared sensor detects the cat's body temperature to measure how close the cat is to the device. The camera sensor visually tracks the cat's movements and records its behavior in detail.

The communication unit uses wireless communication technology to send data from the sensor unit to the server. The communication unit transmits and receives data between the device and the server in real time, quickly providing the server with information about the cat's movement and behavior patterns. This allows the server to analyze the cat's behavior based on the latest data. This enables the server to analyze the cat's behavior based on the latest data.

The generative AI unit operates on the server, analyzing data transmitted from the communication unit. It learns the cat's behavioral patterns and preferences, generating data to provide appropriate reactions and stimuli. For example, it analyzes the speed at which the cat prefers to chase the device and the types of directional changes that interest it. It also learns how the cat reacts to specific sounds and lights, accumulating data to provide optimal stimulation. Specific examples of prompt sentences fed to the generative AI include: "Analyze the speed at which the cat chases and suggest the optimal speed," and "Generate sound and light patterns to capture the cat's interest."

The control unit adjusts the device's operation based on instructions from the generative AI unit. The control unit changes the device's speed and direction to maintain the cat's interest. For example, the device suddenly changes direction or increases speed to keep the cat engaged. The control unit also smooths the device's movements, allowing the cat to chase it naturally.

The audio-visual stimulation unit is mounted on the device and generates sounds and lights to attract the cat's attention. Using speakers and LED lights, the audio-visual stimulation unit can play sounds cats prefer or flash lights in various colors and patterns. For example, it can generate high-pitched chime sounds that interest cats or flashing patterns of red and blue lights to capture their attention.

The user interface unit operates on terminals such as smartphones or tablets, providing an interface for the user to remotely control the device. The user interface unit allows customization of the device's movements and settings through a dedicated application. For example, users can manually adjust the device's speed or set the timing for specific sounds to play. Additionally, the user interface unit displays the device's current status and the cat's behavioral data in real time, providing information for users to adjust how the cat plays. This enables users to monitor the cat's health status and activity level and receive appropriate advice.

### Implementation Steps

### Step 1: Data Collection Step

In this step, the sensors mounted on the device detect the cat's movements and behavior. The accelerometer measures the device's speed and acceleration, detecting how fast the cat is chasing the device. The gyroscope detects the device's rotation and tilt, determining its direction of movement. The infrared sensor detects the cat's body temperature, measuring how close the cat is to the device. The camera sensor visually tracks the cat's movements and records its behavior in detail. This data is transmitted to the server via the communication unit.

### Step 2: Data Analysis Step

The generative AI unit operating on the server receives data transmitted from the communication unit and learns the cat's behavioral patterns and preferences. The generative AI unit analyzes what speed the cat prefers when chasing the device and what direction changes interest it. It also learns how the cat reacts to specific sounds and lights, accumulating data to provide optimal stimulation. Specific examples of prompt sentences to feed the generative AI include: "Analyze the speed at which the cat chases and suggest the optimal speed," and "Generate sound and light patterns to capture the cat's interest."

### Step 3: Motion Control Step

Based on instructions from the generative AI unit, the device's control unit adjusts its movements. The control unit alters the device's speed and direction to maintain the cat's interest. For example, the device may abruptly change direction or accelerate to sustain the cat's engagement. The control unit also smooths the device's motion, enabling the cat to chase it naturally.

### Step 4: Stimulus Provision Step

The audio-visual stimulation unit generates sounds and lights to attract the cat's attention. Using speakers and LED lights, it can play sounds cats prefer or flash lights in various colors and patterns. For example, it can produce high-pitched chime sounds that interest cats or generate flashing patterns of red and blue lights to capture their attention.

### Step 5: User Operation Step

Users can remotely operate the device using terminals such as smartphones or tablets. Through a dedicated application, users can customize the device's movements and settings. For example, users can manually change the device's speed or set the timing for specific sounds to play. Additionally, the application displays the device's current status and the cat's behavioral data in real time, providing information for users to adjust how the cat plays. This allows users to monitor the cat's health status and activity level and receive appropriate advice.

### Specific Use Cases

For instance, in situations where indoor cats tend to become inactive, using the spherical device of the present invention can promote the cat's health. The device is designed to be appealing to cats and uses an accelerometer and gyroscope to track the cat's movements in real time. When the cat chases the device, it adjusts its speed and moves in unpredictable directions to maintain the cat's interest.

The generative AI unit analyzes the cat's movements and behavioral patterns, learning how the cat reacts to different speeds and motions. For example, prompts fed to the generative AI could include instructions like "Identify the speed and direction that most interests the cat" or "Generate the optimal combination of sound and light to capture the cat's attention." This enables the AI to understand the cat's preferences and suggest the best play methods.

The device uses the acoustic and visual stimulation unit to generate sounds and lights to capture the cat's attention. For example, playing high-pitched chime sounds that cats prefer or flashing red and blue lights can sustain the cat's interest. This keeps the cat continuously engaged with the device and encourages active movement.

Users can remotely control the device using a smartphone or tablet. Through a dedicated application, they can customize the device's movements and settings. For example, users can manually adjust the device's speed or set the timing for specific sounds to play. The application also displays the device's current status and the cat's behavioral data in real time, providing information for users to adjust the cat's play style.

In this way, the device of the present invention functions as an effective tool for stimulating a cat's natural hunting instincts and preventing lack of exercise. This enables cats to lead more active and healthy lives, allowing owners to manage their cats' health with peace of mind.

### Application Example 1

The flow of specific processing in Application Example 1 is described below. The components of the system described below are implemented by the data processing device 12 and the smart device 14. The data processing device 12 is referred to as the "server," and the smart device 14 is referred to as the "terminal."

### Implementation Examples for the Present Invention

As an embodiment for implementing the present invention, a system using a spherical device to address insufficient exercise and lack of mental stimulation among the elderly in the care field is described in further detail. This system aims to promote the health of the elderly and improve their quality of life.

The device body features a spherical outer shell and houses multiple sensors internally. Specifically, it includes an accelerometer, gyroscope, infrared sensor, and camera sensor. The accelerometer measures how quickly the elderly user is moving the device. For example, it detects the speed at which an elderly person rolls the device by hand and can evaluate their activity level based on that data. The gyro sensor detects the device's rotation and tilt, understanding how the elderly person is operating it. For instance, it can track in real time which direction the device is rolling and record movement patterns. The infrared sensor detects the elderly person's body temperature and measures their distance from the device. For example, it can be set to automatically react when an elderly person approaches the device. Camera sensors visually track the elderly person's movements and record their actions in detail. For example, they can record video of how the elderly person reacts to the device for later analysis.

Data from these sensors is transmitted to a server via the device's communication module. The communication module uses wireless communication technology to send data to the server in real time. The server analyzes this data using generative AI, learning the elderly person's behavioral patterns and preferences. For example, the server analyzes what speed the elderly person finds comfortable for operating the device and what sounds or lights they show interest in. Furthermore, the AI can assess the elderly person's health status and propose an optimal exercise program. Specific examples of prompt sentences fed to the generative AI include: "Identify the speed at which the elderly person can operate comfortably" and "Generate sound and light patterns to capture the elderly person's interest."

The generative AI unit operates on the server, receiving data transmitted from the communication unit to learn the elderly person's behavioral patterns and preferences. Based on past data, the AI can predict what movements the elderly person prefers and what stimuli they respond to. For example, if the elderly person prefers slow movements, the device's movements are adjusted to be more gradual. Furthermore, if the elderly person shows interest in specific music or colors, stimuli incorporating those elements are provided.

The control unit adjusts the device's operation based on instructions from the generative AI unit. The control unit changes the device's speed and direction to maintain the elderly person's interest. For example, the device may suddenly change direction or increase speed to keep the elderly person engaged. Furthermore, the control unit smooths the device's movements, enabling the elderly person to follow it naturally.

The audio-visual stimulation unit is mounted on the device and generates sounds and lights to attract the elderly person's attention. Using speakers and LED lights, the audio-visual stimulation unit can play sounds preferred by the elderly person or flash lights in various colors and patterns. For example, it can generate high-pitched chime sounds that interest the elderly person or flashing patterns of red and blue lights to capture their attention.

Furthermore, caregivers or family members can remotely operate the device using a smartphone or tablet. Through a dedicated application, they can customize the device's movements and settings. For example, caregivers can manually adjust the device's speed or set the timing for specific sounds to play. The application also displays the device's current status and the elderly person's activity data in real time, enabling caregivers to monitor the elderly person's activities and provide appropriate advice. This allows caregivers to record the elderly person's exercise volume and display goal achievement rates, making it easier to understand the elderly person's health status.

Thus, the present invention provides an effective means within the caregiving field to address insufficient physical activity among the elderly and provide mental stimulation. The device functions as a tool to stimulate the natural movements of the elderly and prevent physical inactivity. This enables the elderly to lead more active and healthy lives, while caregivers and family members can manage the elderly's health with greater peace of mind.

### System Configuration

The system according to this embodiment comprises a sensor unit, a communication unit, a generative AI unit, a control unit, an acoustic/visual stimulation unit, and a user interface unit. The sensor unit includes an accelerometer, a gyroscope, an infrared sensor, and a camera sensor to detect the elderly person's movements and actions. The accelerometer measures how fast the elderly person is moving the device. For example, it can detect the speed at which an elderly person rolls the device by hand and evaluate their activity level based on that data. The gyro sensor detects the device's rotation and tilt to understand how the elderly person is operating it. For example, it can track in real time which direction the device is rolling and record movement patterns. The infrared sensor detects the elderly person's body temperature and measures their distance from the device. For example, it can be set to automatically react when the elderly person approaches the device. The camera sensor visually tracks the elderly person's movements and records their actions in detail. For example, it can record footage of how the elderly person reacts to the device for later analysis.

The communication unit employs wireless communication technology to transmit data from the sensor unit to the server. The communication unit performs real-time data transmission and reception between the device and the server, rapidly providing the server with information regarding the elderly person's movements and behavioral patterns. This enables the server to analyze the elderly person's behavior based on the latest data.

The generative AI unit operates on the server, receiving data transmitted from the communication unit and learning the elderly person's behavioral patterns and preferences. Based on past data, the generative AI unit can predict what movements the elderly person prefers and what stimuli they respond to. For example, if the elderly person prefers slow movements, the device's movements are adjusted to be more gradual. Furthermore, if the elderly person shows interest in specific music or colors, stimuli incorporating those elements are provided. Specific examples of prompts fed to the generative AI include: "Identify the speed at which the elderly can operate comfortably" "Generate sound and light patterns to capture the elderly's interest."

The control unit adjusts the device's operation based on instructions from the generative AI unit. The control unit changes the device's speed and direction to maintain the elderly person's interest. For example, the device may abruptly change direction or increase speed to sustain the elderly person's interest. Furthermore, the control unit smooths the device's movements to enable the elderly person to follow it naturally.

The audio-visual stimulation unit is mounted on the device and generates sounds and lights to capture the elderly person's attention. Using speakers and LED lights, the audio-visual stimulation unit can play sounds preferred by the elderly or flash lights in various colors and patterns. For example, it can generate high-pitched chime sounds that interest the elderly or flashing patterns of red and blue lights to grab their attention.

The user interface unit operates on terminals such as smartphones or tablets, providing an interface for caregivers or family members to remotely control the device. The user interface unit allows customization of the device's movements and settings through a dedicated application. For example, caregivers can manually adjust the device's speed or set the timing for specific sounds to play. Furthermore, the user interface unit displays the device's current status and the elderly person's activity data in real time, providing information for caregivers to monitor the elderly person's activities and offer appropriate advice. This enables caregivers to record the elderly person's exercise volume and display goal achievement rates, making it easier to understand the elderly person's health status.

### Implementation Steps

### Step 1: Data Collection Step

In this step, the sensor unit mounted on the device detects the elderly person's movements and actions. The accelerometer measures how fast the elderly person is moving the device. For example, it can detect the speed at which the elderly person rolls the device by hand and evaluate the amount of exercise based on that data. The gyroscope detects the device's rotation and tilt, understanding how the elderly person is operating the device. For instance, it can track in real time which direction the device is rolling and record movement patterns. An infrared sensor detects the elderly person's body temperature and measures their distance from the device. For example, it can be set to react automatically when the elderly person approaches the device. A camera sensor visually tracks the elderly person's movements and records their actions in detail. For example, it can record footage of how the elderly person reacts to the device for later analysis.

### Step 2: Data Transmission Step

Data collected by the sensor unit is transmitted to the server via the communication unit. The communication unit uses wireless communication technology to send data to the server in real time. This enables the server to analyze the elderly person's behavior based on the latest data.

### Step 3: Data Analysis Step

The generative AI unit operating on the server receives data transmitted from the communication unit and learns the elderly person's behavioral patterns and preferences. Based on past data, the generative AI unit can predict what movements the elderly person prefers and what stimuli they respond to. For example, if the elderly person prefers slow movements, the device's movements are adjusted to be more gradual. Furthermore, if the elderly person shows interest in specific music or colors, stimuli incorporating those elements are provided. Specific examples of prompt sentences fed to the generative AI include: "Identify the speed at which the elderly can operate comfortably" and "Generate sound and light patterns to capture the elderly's interest."

### Step 4: Motion Control Step

Based on instructions from the generative AI unit, the control unit adjusts the device's operation. The control unit changes the device's speed and direction to maintain the elderly person's interest. For example, the device suddenly changes direction or increases speed to keep the elderly person engaged. Furthermore, the control unit smooths the device's movements, enabling the elderly person to follow it naturally.

### Step 5: Stimulus Provision Step

The audio-visual stimulation unit generates sounds and lights to capture the elderly person's attention. Using speakers and LED lights, the audio-visual stimulation unit can play sounds preferred by the elderly or flash lights in various colors and patterns. For example, it can generate high-pitched chime sounds that interest the elderly or flashing patterns of red and blue lights to grab their attention.

### Step 6: User Operation Step

Caregivers or family members can remotely operate the device using a smartphone or tablet. Through a dedicated application, they can customize the device's movements and settings. For example, caregivers can manually adjust the device's speed or set the timing for specific sounds to play. The application also displays the device's current status and the elderly person's activity data in real time, providing information for caregivers to monitor the elderly person's activities and offer appropriate advice. This allows caregivers to record the elderly person's exercise volume and display goal achievement rates, making it easier to understand the elderly person's health status.

### Specific Use Cases

For example, in care facilities where concerns exist about elderly residents routinely becoming physically inactive, utilizing the spherical device of this invention can promote their health. This device incorporates an accelerometer, gyroscope, infrared sensor, and camera sensor to detect the elderly person's movements and actions in real time. When an elderly person rolls the device by hand, the accelerometer measures its speed, and the gyroscope detects the device's rotation and tilt. This allows for detailed understanding of how the elderly person is operating the device.

Generative AI analyzes these data to identify behavioral patterns and generates optimal exercise programs for each individual. For example, the AI analyzes the speed at which the elderly find device operation comfortable and adjusts the device's movement accordingly. Furthermore, if the elderly show interest in specific music or colors, the AI provides stimuli incorporating these elements. Examples of prompt sentences fed to the generative AI include: "Identify the speed at which the elderly can operate comfortably" and "Generate sound and light patterns to capture the elderly's interest."

The device provides appropriate reactions and stimuli to the elderly based on the AI's analysis results. Specifically, the device adjusts its speed or changes direction to maintain the elderly person's interest. Furthermore, the device is equipped with speakers and LED lights, enabling it to play music or flash colorful lights to capture the elderly person's attention. This allows the elderly to maintain continuous interest in the device and naturally promotes physical activity.

Furthermore, caregivers and family members can remotely control the device via smartphones or tablets. Using a dedicated application, they can customize the device's movements and settings. For example, caregivers can manually change the device's speed or set the timing for specific sounds to play. The application also displays the device's current status and the elderly person's activity data in real time, enabling caregivers to monitor the elderly person's activities and provide appropriate advice.

In this way, the device of the present invention functions as an effective tool for stimulating the natural movements of the elderly and preventing physical inactivity. This enables the elderly to lead more active and healthy lives, while caregivers and family members can manage the elderly's health with peace of mind.

The specific processing unit 290 transmits the results of the specific processing to the smart device 14. On the smart device 14, the control unit 46A instructs the output device 40 to output the results of the specific processing. The microphone 38B acquires audio indicating user input regarding the results of the specific processing. The control unit 46A transmits the audio data indicating the user input acquired by the microphone 38B to the data processing unit 12. At the data processing unit 12, the specific processing unit 290 acquires the audio data.

The data generation model 58 is a so-called generative AI (Artificial Intelligence). An example of the data generation model 58 is ChatGPT (registered trademark) (Internet search <URL: https://openai.com/blog/chatgpt>). The data generation model 58 is obtained by performing deep learning on a neural network. The data generation model 58 receives input of a prompt containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58. The data generation model 58 includes AI other than generative AI. AI other than generative AI includes, for example, linear regression, logistic regression, decision trees, random forests, support vector machines (SVM), k-means clustering, convolutional neural networks (CNN), and recurrent neural networks(RNN), generative adversarial networks (GAN), or naive Bayes, among others. The AI may perform various processing operations, but is not limited to such examples. Furthermore, the AI may be an AI agent. Also, when the processing of the aforementioned components is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing by the data processing system 10 described above may be executed by the specific processing unit 290 of the data processing device 12 or by the control unit 46A of the smart device 14. Alternatively, the processing may be executed by the specific processing unit 290 of the data processing device 12 and the control unit 46A of the smart device 14. Furthermore, the data processing device 12's specific processing unit 290 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the smart device 14.

### Second Embodiment

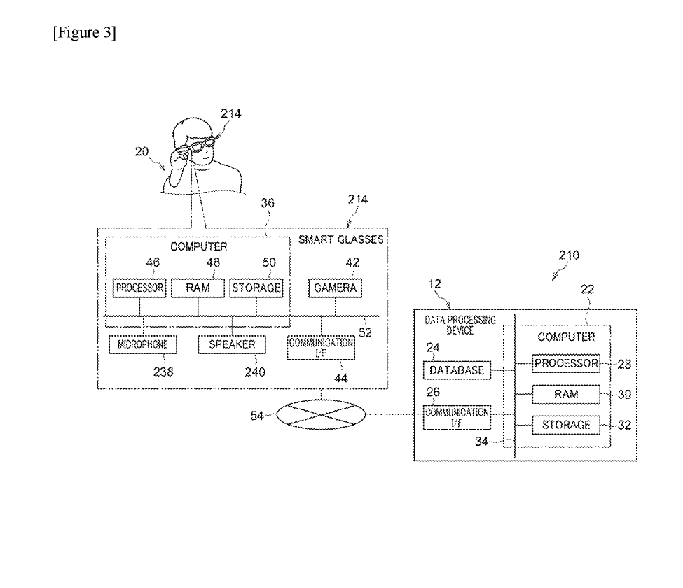

FIG. 3 shows an example configuration of the data processing system 210 according to the second embodiment.

As shown in FIG. 3, the data processing system 210 includes a data processing device 12 and smart glasses 214. An example of the data processing device 12 is a server.

The data processing device 12 includes a computer 22, a database 24, and a communication I/F 26. The computer 22 is an example of a "computer" according to the technology of the present disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 include a WAN (Wide Area Network) and/or a LAN (Local Area Network).

The smart glasses 214 include a computer 36, a microphone 238, a speaker 240, a camera 42, and a communication I/F 44. The computer 36 includes a processor 46, RAM 48, and storage 50. Processor 46, RAM 48, and storage 50 are connected to bus 52. Microphone 238, speaker 240, and camera 42 are also connected to bus 52.

Microphone 238 receives voice input from user 20 to accept instructions or other commands. Microphone 238 captures the voice input from user 20, converts the captured voice into audio data, and outputs it to processor 46. Speaker 240 outputs audio in accordance with instructions from processor 46.

Camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor. It captures images of the user's surroundings (e.g., within a field of view equivalent to that of a typical healthy individual).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

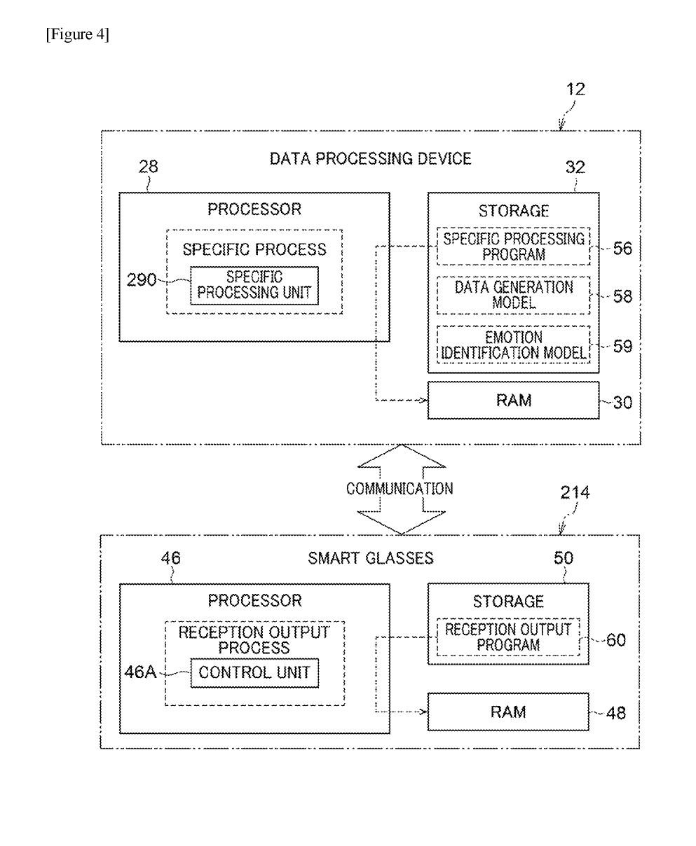

FIG. 4 shows an example of the key functions of the data processing device 12 and the smart glasses 214. As shown in FIG. 4, specific processing is performed by the processor 28 in the data processing device 12. The specific processing program 56 is stored in the storage 32.

The specific processing program 56 is an example of a "program" related to the technology of this disclosure. The processor 28 reads the specific processing program 56 from the storage 32 and executes the read specific processing program 56 on the RAM 30. The specific processing is realized by the processor 28 operating as a specific processing unit 290 according to the specific processing program 56 executed on the RAM 30.

Storage 32 stores a data generation model 58 and an emotion identification model 59. The data generation model 58 and emotion identification model 59 are used by specific processing unit 290. Specific processing unit 290 can estimate a user's emotion using emotion identification model 59 and perform specific processing using the user's emotion. The emotion estimation function (emotion identification function) using the emotion identification model 59 performs various estimations and predictions concerning the user's emotion, including estimation and prediction of the user's emotion, but is not limited to such examples. Furthermore, estimation and prediction of emotion includes, for example, analysis (parsing) of emotion.

In the smart glasses 214, the processor 46 performs the reception output processing. The reception output program 60 is stored in the storage 50. The processor 46 reads the reception output program 60 from the storage 50 and executes the read reception output program 60 on the RAM 48. The reception output processing is realized by the processor 46 operating as the control unit 46A according to the reception output program 60 executed on the RAM 48. The reception output processing is performed by the processor 46 acting as a control unit 46A according to the reception output program 60 executed on RAM 48. Note that the smart glasses 214 may also have a data generation model 58 and an emotion identification model 59, and can perform processing similar to that of the identification processing unit 290 using these models.

Next, the identification processing performed by the identification processing unit 290 of the data processing device 12 is described. The components of the system described below are implemented by the data processing device 12 and the smart glasses 214. In the following description, the data processing device 12 is referred to as the "server," and the smart glasses 214 are referred to as the "terminal."

### Example 1

The flow of the specific processing is the same as that described in Example 1 of the first embodiment, so the explanation is omitted.

### Application Example 1

The flow of the specific processing in Example 1 described in the first embodiment is the same as described above, so the explanation is omitted.

The specific processing unit 290 transmits the result of the specific processing to the smart glasses 214. In the smart glasses 214, the control unit 46A causes the speaker 240 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data.

The data generation model 58 is a so-called generative AI (Artificial Intelligence). An example of the data generation model 58 is ChatGPT (registered trademark) (Internet search <URL: https://openai.com/blog/chatgpt>). The data generation model 58 is obtained by performing deep learning on a neural network. The data generation model 58 receives input of a prompt containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58. The data generation model 58 includes AI other than generative AI. AI other than generative AI includes, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but is not limited to such examples. The AI may also be an AI agent. Furthermore, when the processing of the aforementioned components is performed by the AI, such processing may be performed in part or in whole by the AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using the generated AI. For example, the provision unit is implemented by the output device 40 of the smart device 14 or the specific processing unit 290 of the data processing device 12 and provides the generated cooking menu. The generation unit is implemented by the specific processing unit 290 of the data processing device 12 and generates a cooking menu using generative AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the smart glasses 214.

### Third Embodiment

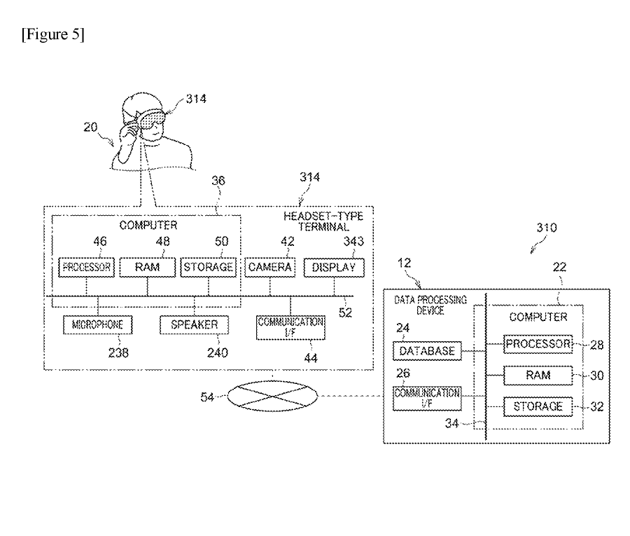

FIG. 5 shows an example configuration of the data processing system 310 according to the third embodiment.

As shown in FIG. 5, the data processing system 310 includes a data processing device 12 and a headset-type terminal 314. An example of the data processing device 12 is a server.

The data processing device 12 includes a computer 22, a database 24, and a communication I/F 26. The computer 22 is an example of a "computer" according to the technology of the present disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 include a WAN (Wide Area Network) and/or a LAN (Local Area Network).

The headset-type terminal 314 comprises a computer 36, a microphone 238, a speaker 240, a camera 42, a communication interface 44, and a display 343. The computer 36 includes a processor 46, RAM 48, and storage 50. The processor 46, RAM 48, and storage 50 are connected to a bus 52. The microphone 238, speaker 240, camera 42, and display 343 are also connected to the bus 52.

Microphone 238 receives voice input from user 20 to accept instructions or other commands. Microphone 238 captures the voice input from user 20, converts the captured voice into audio data, and outputs it to processor 46. Speaker 240 outputs audio according to instructions from processor 46.

The camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor. It captures images of the user's surroundings (e.g., within a field of view equivalent to that of a typical healthy individual).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

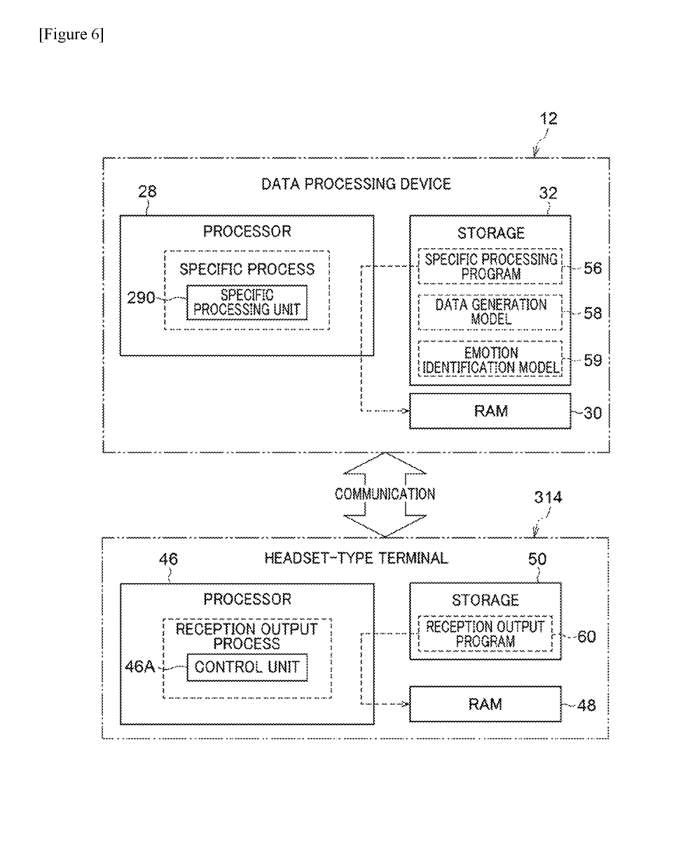

FIG. 6 illustrates an example of key functions of the data processing device 12 and the headset-type terminal 314. As shown in FIG. 6, specific processing is performed by the processor 28 within the data processing device 12. The specific processing program 56 is stored in the storage 32.

The specific processing program 56 is an example of a "program" related to the technology of the present disclosure. The processor 28 reads the specific processing program 56 from the storage 32 and executes the read specific processing program 56 on the RAM 30. The specific processing is realized by the processor 28 operating as the specific processing unit 290 according to the specific processing program 56 executed on the RAM 30.

Storage 32 stores a data generation model 58 and an emotion identification model 59. The data generation model 58 and the emotion identification model 59 are used by the specific processing unit 290.

In the headset-type terminal 314, reception output processing is performed by the processor 46. The reception output program 60 is stored in the storage 50. Processor 46 reads the reception output program 60 from storage 50 and executes the read reception output program 60 on RAM 48. Reception output processing is achieved by processor 46 operating as control unit 46A according to the reception output program 60 executed on RAM 48.

Next, the specific processing performed by the specific processing unit 290 of the data processing device 12 is described. The various parts of the system described below are implemented by the data processing device 12 and the headset-type terminal 314. In the following description, the data processing device 12 is referred to as the "server," and the headset-type terminal 314 is referred to as the "terminal."

### Example 1

The flow of the specific processing is the same as that described in Example 1 of the first embodiment, so the description is omitted.

### Application Example 1

The flow of the specific processing in Example 1 described in the above first embodiment is the same, so the explanation is omitted.

The specific processing unit 290 transmits the result of the specific processing to the headset-type terminal 314. At the headset-type terminal 314, the control unit 46A causes the speaker 240 and the display 343 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data.

The data generation model 58 is a so-called generative AI (Artificial Intelligence). An example of the data generation model 58 is ChatGPT (registered trademark) (Internet search <URL: https://openai.com/blog/chatgpt>). The data generation model 58 is obtained by performing deep learning on a neural network. The data generation model 58 receives input prompts containing instructions, as well as inference data such as audio data representing sound, text data representing text, and image data (e.g., still image data or video data) representing images. The data generation model 58 infers based on the instructions indicated by the prompt using the input inference data and outputs the inference result in one or more data formats, such as audio data, text data, and image data. The data generation model 58 includes, for example, text generation AI, image generation AI, multimodal generation AI, etc. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58. The data generation model 58 includes AI other than generative AI. AI other than generative AI includes, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but is not limited to such examples. Furthermore, the AI may be an AI agent. Also, when the processing of the aforementioned components is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the acquisition unit is implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the headset-type terminal 314.

### Fourth Embodiment

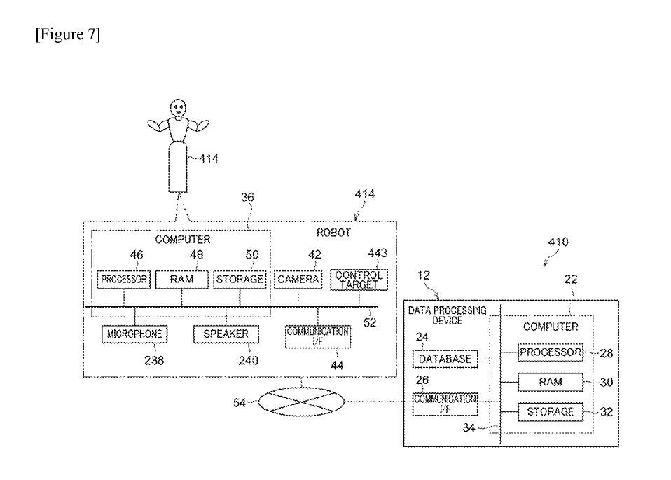

FIG. 7 shows an example configuration of the data processing system 410 according to the fourth embodiment.

As shown in FIG. 7, the data processing system 410 includes a data processing device 12 and a robot 414. An example of the data processing device 12 is a server.

The data processing device 12 includes a computer 22, a database 24, and a communication I/F 26. The computer 22 is an example of a "computer" according to the technology of the present disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 include a WAN (Wide Area Network) and/or a LAN (Local Area Network).

Robot 414 includes a computer 36, a microphone 238, a speaker 240, a camera 42, a communication I/F 44, and a control target 443. Computer 36 includes a processor 46, RAM 48, and storage 50. Processor 46, RAM 48, and storage 50 are connected to bus 52. Furthermore, microphone 238, speaker 240, camera 42, and controlled object 443 are also connected to bus 52.

Microphone 238 receives voice input from user 20 to accept instructions or other commands. Microphone 238 captures the voice input from user 20, converts the captured voice into audio data, and outputs it to processor 46. Speaker 240 outputs audio in accordance with instructions from processor 46.

The camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor. It captures images of the user's surroundings (e.g., an imaging range defined by a field of view equivalent to that of a typical healthy person).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

The control target 443 includes a display device, LEDs for the eye section, and motors for driving the arms, hands, legs, etc. The posture and gestures of robot 414 are controlled by controlling the motors for the arms, hands, legs, etc. Part of the robot 414's emotions can be expressed by controlling these motors. Furthermore, the robot 414's facial expressions can also be expressed by controlling the light emission state of the LEDs in its eyes.

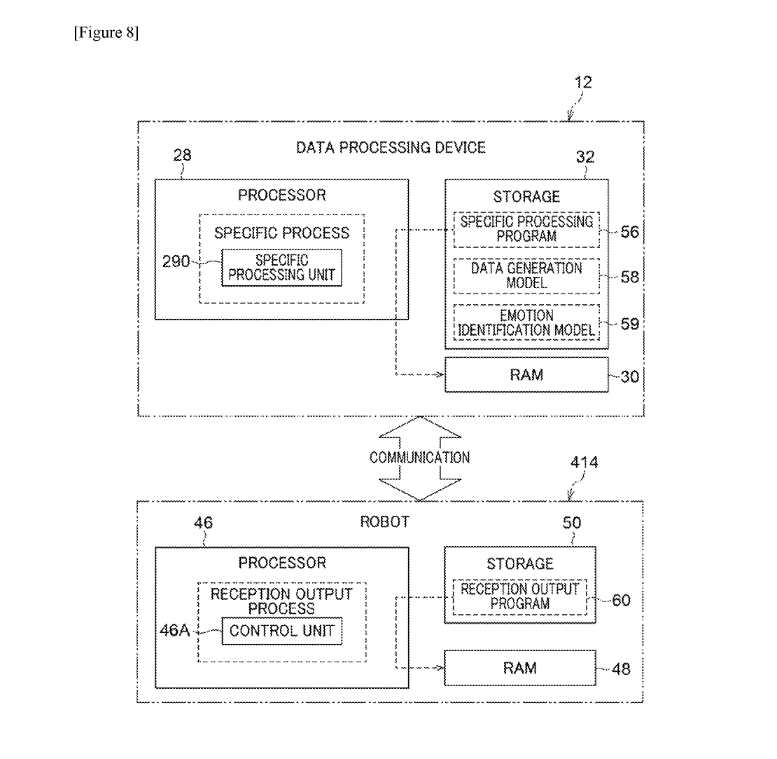

FIG. 8 shows an example of the main functions of the data processing device 12 and the robot 414. As shown in FIG. 8, specific processing is performed by the processor 28 in the data processing device 12. The specific processing program 56 is stored in the storage 32.

The specific processing program 56 is an example of a "program" related to the technology of this disclosure. The processor 28 reads the specific processing program 56 from the storage 32 and executes the read specific processing program 56 on the RAM 30. The specific processing is realized by the processor 28 operating as a specific processing unit 290 according to the specific processing program 56 executed on the RAM 30.

Storage 32 stores a data generation model 58 and an emotion identification model 59. The data generation model 58 and the emotion identification model 59 are used by specific processing unit 290.

In robot 414, reception output processing is performed by processor 46. Storage 50 stores a reception output program 60. Processor 46 executes the reception output program 60 stored in storage, read the reception output program 60 from memory location 50 and execute the read reception output program 60 in RAM 48. The reception output processing is realized by the processor 46 operating as the control unit 46A according to the reception output program 60 executed in RAM 48.

Next, the specific processing performed by the specific processing unit 290 of the data processing device 12 is described. The various parts of the system described below are implemented by the data processing device 12 and the robot 414. In the following description, the data processing device 12 is referred to as the "server," and the robot 414 is referred to as the "terminal."

### Example 1

The flow of the specific processing is the same as that described in Example 1 of the first embodiment, so the description is omitted.

### Application Example 1

The flow of the specific processing in Example 1 described in the first embodiment is the same as described above, so the explanation is omitted.

The specific processing unit 290 transmits the result of the specific processing to the robot 414. In the robot 414, the control unit 46A causes the speaker 240 and the control target 443 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data.

The data generation model 58 is a so-called generative AI (Artificial Intelligence). An example of the data generation model 58 is ChatGPT (registered trademark) (Internet search <URL: https://openai.com/blog/chatgpt>). The data generation model 58 is obtained by performing deep learning on a neural network. The data generation model 58 receives input prompts containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12 and the like include multiple types of data generation models 58, and the data generation model 58 includes AI other than generative AI. AI other than generative AI includes, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but is not limited to such examples. AI may also be an AI agent. Furthermore, when processing by the aforementioned components is performed by AI, such processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the acquisition unit is implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the robot 414.

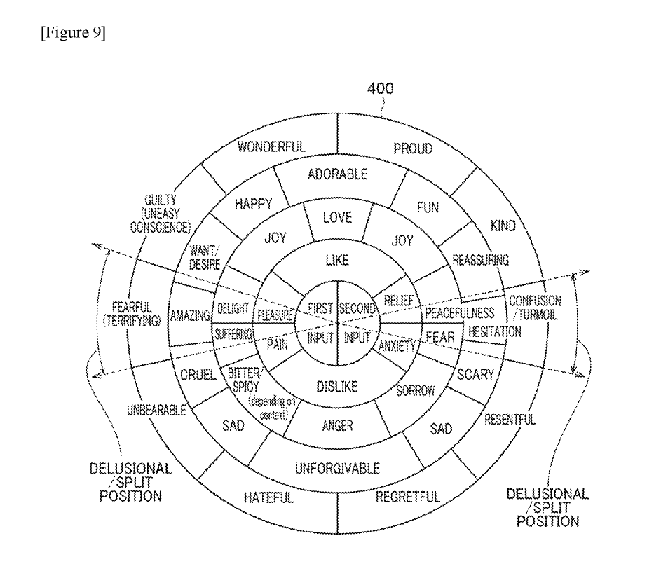

The emotion identification model 59, functioning as an emotion engine, may determine the user's emotion according to a specific mapping. Specifically, the emotion identification model 59 may determine the user's emotion according to an emotion map (see FIG. 9), which is a specific mapping. Furthermore, the emotion identification model 59 may similarly determine the robot's emotion, and the specific processing unit 290 may perform specific processing using the robot's emotion.

FIG. 9 is a diagram showing an emotion map 400 where multiple emotions are mapped. In the emotion map 400, emotions are arranged radially in concentric circles from the center. Emotions closer to the center of the concentric circles represent more primitive states. Emotions representing states or behaviors arising from mental states are arranged further out in the concentric circles. Emotion is a concept encompassing affect and mental states. Generally, emotions generated from reactions occurring within the brain are placed on the left side of the concentric circles. Generally, emotions induced by situational judgment are placed on the right side of the concentric circles. Generally, emotions generated from reactions occurring within the brain and also induced by situational judgment are placed on the upper and lower sides of the concentric circles. Furthermore, the upper part of the concentric circle contains "pleasant" emotions, while the lower part contains "unpleasant" emotions. Thus, the Emotion Map 400 maps multiple emotions based on the structure of their origin, with emotions that tend to occur simultaneously mapped close together.

These emotions are distributed around the 3 o'clock position on Emotion Map 400, typically oscillating between feelings of security and anxiety. In the right half of Emotion Map 400, situational awareness takes precedence over internal sensations, resulting in a calmer impression.

The inner part of the emotion map 400 represents the mind, while the outer part represents behavior. Therefore, the further out on the emotion map 400, the more visible the emotion becomes (manifesting in behavior).

Here, human emotions are based on various balances, such as posture and blood sugar levels. When these balances deviate from the ideal, it indicates a state of discomfort; when they approach the ideal, it indicates a state of comfort. Similarly, for robots, automobiles, motorcycles, etc., emotions can be created based on various balances, such as posture and battery level. When these balances deviate from the ideal, it indicates a state of discomfort; when they approach the ideal, it indicates a state of comfort. Emotion maps, for example, Dr. Mitsuyoshi's Emotion Map (Research on Speech Emotion Recognition and Neurophysiological Signal Analysis of Emotions, Tokushima University, Doctoral Dissertation: https://ci.nii.ac.jp/naid/500000375379). The left half of the emotion map displays emotions belonging to the "Reaction" area, where sensory input dominates. The right half of the emotion map displays emotions belonging to the "Situation" domain, where situational awareness is dominant.

The emotion map defines two emotions that promote learning. One is the negative emotion around the center of the "repentance" or "reflection" area on the situation side. That is, when the robot experiences negative emotions like "I never want to feel this way again" or "I don't want to be scolded anymore." The other is the positive emotion around "desire" on the reaction side. That is, when the robot feels positive emotions like "I want more" or "I want to know more."

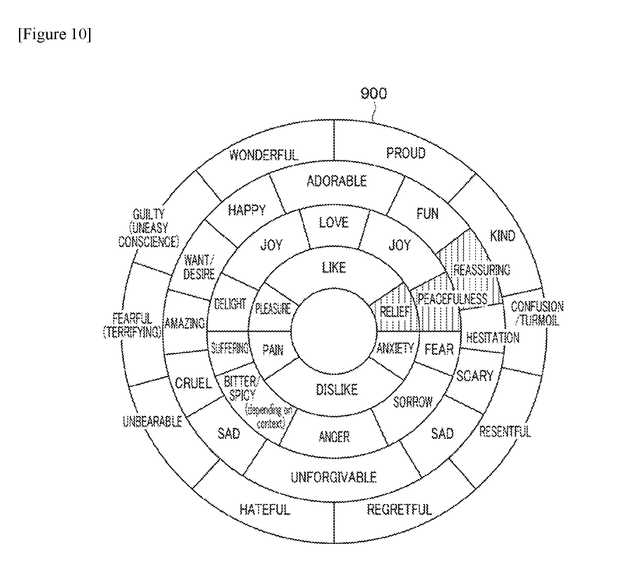

The emotion identification model 59 inputs the user input into a pre-trained neural network, obtains emotion values corresponding to each emotion shown in the emotion map 400, and determines the user's emotion. This neural network is pre-trained based on multiple training data sets, which are combinations of user input and emotion values corresponding to each emotion shown in the emotion map 400. Furthermore, this neural network is trained such that emotions positioned close to each other, as shown in the emotion map 900 in FIG. 10, have similar values. FIG. 10 illustrates an example where multiple emotions, such as "reassurance," "tranquility," and "encouragement," have similar emotion values.

The above description primarily explains the system of the present disclosure in terms of the functions of the data processing device 12. However, the system of the present disclosure is not necessarily implemented on a server. The system of the present disclosure may be implemented as a general information processing system. For example, the present disclosure may be implemented as a software program operating on a personal computer or as an application operating on a smartphone or similar device. The method of the present disclosure may be provided to users in a SaaS (Software as a Service) format.

The above embodiment illustrated an example configuration where specific processing is performed by a single computer 22. However, the technology of this disclosure is not limited thereto. Distributed processing may be performed by multiple computers, including computer 22, for specific processing. For example, data generation model 58 may be provided on an external device of data processing device 12, and said external device may generate data corresponding to input data. For example, the data generation model 58 may be provided in an external device of the data processing device 12, and data generation corresponding to input data may be performed in said external device.

The above embodiment described a configuration where the specific processing program 56 is stored in the storage 32. However, the technology disclosed herein is not limited to this. For example, the specific processing program 56 may be stored on a portable, computer-readable non-volatile storage medium, such as a USB (Universal Serial Bus) memory. The specific processing program 56 stored on the non-volatile storage medium is installed on the computer 22 of the data processing device 12. The processor 28 executes specific processing according to the specific processing program 56.

Alternatively, the specific processing program 56 may be stored on a storage device, such as a server, connected to the data processing device 12 via the network 54. Upon request from the data processing device 12, the specific processing program 56 is downloaded and installed on the computer 22.

It should be noted that it is not necessary to store the entire specific processing program 56 in a storage device such as a server connected to the data processing device 12 via the network 54, or to store the entire specific processing program 56 in the storage 32. It is also possible to store only a portion of the specific processing program 56.

Various types of processors can be used as hardware resources to execute the specific processing. Examples of processors include a CPU, which is a general-purpose processor that functions as a hardware resource for executing specific processing by executing software, i.e., a program. Additionally, processors may include dedicated electronic circuits, such as FPGAs (Field-Programmable Gate Array), PLDs (Programmable Logic Device), or ASICs (Application Specific Integrated Circuit), which are processors with circuit configurations specifically designed to execute particular processing. Each processor incorporates or connects to memory, and each processor executes specific processing by using this memory.

The hardware resources for executing specific processing may be comprised of one of these various processors, or may be comprised of a combination of two or more processors of the same or different types (e.g., a combination of multiple FPGAs, or a combination of a CPU and an FPGA). Furthermore, the hardware resources for executing specific processing may be comprised of a single processor.

Examples of configurations using a single processor include, first, a form where one processor is composed of a combination of one or more CPUs and software, functioning as a hardware resource that executes specific processing. Second, there is a form that uses a processor, such as a System-on-a-chip (SoC), which implements the entire system's functionality—including multiple hardware resources for executing specific processing—on a single IC chip. Thus, specific processing is realized as hardware resources using one or more of the aforementioned types of processors.

Furthermore, regarding the hardware structure of these various processors, more specifically, electrical circuits combining circuit elements such as semiconductor devices can be used. Also, the specific processing described above is merely one example. Therefore, it goes without saying that unnecessary steps may be omitted, new steps may be added, or the processing order may be changed, provided such changes do not deviate from the main purpose.

The above description and illustrations provide a detailed explanation of the aspects pertaining to the technology of this disclosure and represent merely one example of the technology disclosed herein. For example, the explanations regarding the configuration, functions, operations, and effects described above are examples of the configuration, functions, operations, and effects pertaining to the aspects of the technology disclosed herein. Therefore, it goes without saying that within the scope of not deviating from the essence of the technology of this disclosure, unnecessary portions may be deleted, new elements may be added, or replacements may be made to the above-described content and illustrated content. Furthermore, to avoid complexity and facilitate understanding of the part pertaining to the technology of this disclosure, descriptions of technical common knowledge, etc., that are particularly unnecessary for enabling the implementation of the technology of this disclosure have been omitted from the above-described content and illustrated content.

All literature, patent applications, and technical specifications cited herein are incorporated by reference to the same extent as if each individual literature, patent application, and technical specification were specifically and individually cited herein.

The following further discloses the embodiments described above.

### Supplementary Note 1

A system comprising: a sensor unit including an accelerometer, a gyroscope, an infrared sensor, and a camera sensor; a generative AI unit that receives data from said sensor unit and analyzes the movements and behavioral patterns of elderly individuals; a control unit that provides appropriate reactions or stimuli to the elderly based on the analysis results from said generative AI unit; and a communication unit for remotely operating the device via a smartphone or tablet.

In the system described in Supplementary Note 1, the control unit adjusts the device's speed and direction to maintain the elderly person's interest, and provides stimuli to capture their attention by using an audio-visual stimulation unit to play music or flash colorful lights. This enables the elderly person to maintain continuous interest in the device and naturally promotes physical activity.

In the system described in Supplementary Note 1, the communication unit enables caregivers or family members to customize the device's movements and settings using a dedicated application, and to display the device's current status and the elderly person's activity data in real time. This allows caregivers to monitor the elderly person's activities, provide appropriate advice, and more easily understand the elderly person's health status.

### EXPLANATION OF SYMBOLS

10, 210, 310, 410 Data Processing System

12 Data Processing Device

14 Smart Device

214 Smart Glasses

314 Headset-type terminal

414 Robot

What is claimed is:

1. An emotion-adaptive interactive control system comprising:
a server device including:
at least one processor;
a non-transitory storage storing executable instructions, a trained emotion identification model, and a trained response generation model; and
a communication interface configured to communicate with at least one terminal device over a network;
wherein the at least one processor, upon execution of the executable instructions, is configured to:
receive user input data from the terminal device, the user input data including at least one of audio data, text data, or image data;
input the user input data into the trained emotion identification model to generate a multi-dimensional emotion value vector corresponding to a predefined emotion mapping space;
generate a structured emotion state representation based on the multi-dimensional emotion value vector;
input the structured emotion state representation into the trained response generation model to generate response control data;
transmit the response control data to the terminal device; and
update at least one parameter of the structured emotion state representation based on subsequent user input data, thereby forming a closed-loop emotion-adaptive control process.

2. The system of claim 1, wherein the predefined emotion mapping space comprises a two-axis coordinate space representing valence and arousal dimensions.

3. The system of claim 1, wherein the multi-dimensional emotion value vector includes values corresponding to a plurality of predefined emotion categories mapped according to spatial proximity relationships.

4. The system of claim 1, wherein the response control data includes at least one of synthesized speech parameters, text generation parameters, image generation parameters, or mechanical actuation control signals.

5. The system of claim 1, wherein updating includes adjusting an emotion smoothing parameter to reduce abrupt emotion state transitions.

6. The system of claim 1, wherein the server device maintains a session state identifier linking generated responses to corresponding subsequent user input data.

7. A computer-implemented method executed by at least one processor of a server device, comprising:
receiving user input data including at least one of audio data, text data, or image data;
processing the user input data using a trained emotion identification model to generate a multi-dimensional emotion value vector;
mapping the multi-dimensional emotion value vector into a structured emotion state representation within a predefined emotion mapping space;
executing a trained response generation model using the structured emotion state representation to generate response control data;
transmitting the response control data to a terminal device for output;
receiving subsequent user input data; and
modifying at least one emotion state parameter based on the subsequent user input data.

8. The method of claim 7, wherein mapping includes normalizing emotion values based on historical session data.

9. The method of claim 7, wherein executing the trained response generation model includes selecting a response template corresponding to a region of the predefined emotion mapping space.

10. The method of claim 7, wherein the response control data includes motor control signals for actuating a robotic device.

11. The method of claim 7, wherein modifying includes applying a weighted temporal decay function to prior emotion state parameters.

12. The method of claim 7, further comprising storing the structured emotion state representation and corresponding response outcomes in a database for periodic retraining of the emotion identification model.

13. A non-transitory computer-readable storage medium storing instructions that, when executed by at least one processor, cause the at least one processor to:
receive multimodal user input data;
generate a multi-dimensional emotion value vector using a trained neural network;
determine a structured emotion state representation within a predefined emotion mapping space;
generate response control data using a trained response generation model based on the structured emotion state representation;
transmit the response control data to a terminal device; and
update at least one parameter of the structured emotion state representation based on additional user input data.

14. The non-transitory computer-readable storage medium of claim 13, wherein the predefined emotion mapping space is represented as a coordinate grid in which spatial proximity corresponds to emotional similarity.

15. The non-transitory computer-readable storage medium of claim 13, wherein the trained emotion identification model is trained using labeled datasets associating user input patterns with predefined emotion values.

16. The non-transitory computer-readable storage medium of claim 13, wherein the response generation model comprises a multimodal generative neural network configured to output at least one of text, speech, or image data.

17. The non-transitory computer-readable storage medium of claim 13, wherein updating includes recalculating a dominant emotion value based on a weighted combination of current and prior emotion values.

18. The non-transitory computer-readable storage medium of claim 13, wherein the instructions further cause the processor to adjust output intensity based on a magnitude of the multi-dimensional emotion value vector.
